(19) United States
(12) Patent Application Publication
(10) Pub. No.: US 2004/0267749 A1
(43) Pub. Date: Dec. 30, 2004

(54) Resource name interface for managing policy resources

(76) Inventors: Shivaram Bhat, Sunnyvale, CA (US); Hua Cui, Fremont, CA (US); Ping Luo, Union City, CA (US); Dilli Dorai Minnal Arumugam, Cupertino, CA (US); Aravindan Ranganathan, San Jose, CA (US)

Correspondence Address: OSHA & MAY L.L.P./SUN, 1221 MCKINNEY, SUITE 2800, HOUSTON, TX, 77010, US

(21) Appl. No.: 10/608,881

(22) Filed: Jun. 26, 2003

(51) Int. Cl. G06F 7/00

(52) U.S. Cl. 707/9

(57) ABSTRACT

Methods and systems thereof for managing resources are described. A list of resources is accessed. The names of the resources are compared so that relationships between the resources can be determined. For example, one resource can be identified as a sub-resource of another resource. The resources can then be represented in an organizational structure based on their relationships. The organizational structure can be readily traversed to locate a resource by name. Once the resource is located by name, a determination can be made as to whether the resource is subject to an access control policy.

### BACKGROUND OF THE INVENTION

1. Field of the Invention

The field of the invention relates to computer-implemented policies for controlling access to private resources.

2. Related Art

In a corporate environment, users on an internal network (e.g., an Intranet) have access to resources that would not typically be accessible to users that are not connected to the internal network. By limiting the use of these resources to users connected to the internal network, a degree of security can be provided because only users inside the corporation can access the applications. Although somewhat secure, users can find this approach inconvenient, because some users need to access applications on a corporate server when they are not at the office (and thus not connected via an Intranet).

To overcome this problem, some networks are configured to allow remote access to a server over the Internet. To achieve secure remote access to a server, corporations create a “portal” for users to log into the server while not connected to the Intranet. Typically, a user will provide credentials such as a user name and password to gain access to the server over the Internet. Policies are defined and enforced that control access to particular resources available on the server, to prevent unauthorized use of those resources. These policies reside on a policy server. Once an authenticated user has been granted access to a server and requests access to a resource on the server, the server checks with the policy server to verify that the user is authorized to access the resource. Such a system can also be used to control access to resources when users access the server via the internal network.

In a typical enterprise, there can be many resources (several thousands or more) and almost as many access control policies. In response to a request for access to a resource, one of the first steps is to determine whether the resource is subject to an access control policy. If so, then the request can be evaluated against that policy to determine whether the user can be granted access to the requested resource. It is important that these activities be performed quickly, because the user does not want to be delayed when attempting to access a resource. In addition, it is desirable to minimize to a practical extent the computational resources used for access control.

### SUMMARY OF THE INVENTION

Accordingly, a method and/or system that can more efficiently implement access control policies would be of value. Embodiments of the present invention provide such a solution.

According to one embodiment of the present invention, a list of resources is accessed. The names of the resources are compared so that relationships between the resources can be determined. For example, one resource can be identified as a sub-resource of another resource. The resources can then be represented in an organizational structure based on their relationships. The organizational structure can be readily traversed to locate a resource by name. Once the resource is located by name, it can be determined whether the resource is subject to an access control policy.

In one embodiment, the resource names have a number of components that are separated by some type of delimiter. According to the embodiments of the present invention, the type of delimiter is specified to facilitate the comparison of resource names. Also, wildcard pattern matching of names can be used to facilitate the comparison. In addition, whether or not resource names are case-sensitive can be considered in the comparison.

Therefore, according to the various embodiments of the invention, the names of resources can be represented in an organizational structure that facilitates a search of those names. Once a resource is located by name, a determination can be made as to whether the resource is subject to an access control policy. If so, a request for the resource can be evaluated against the policy to determine whether the requestor has permission to access the resource. Even in an environment in which a large number of resources are present, the listing of resources can be speedily traversed, reducing the time needed for the policy evaluation and also conserving computational resources.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of an exemplary computer system upon which embodiments of the present invention can be implemented.

FIG. 2 illustrates an access control policy architecture in accordance with one embodiment of the present invention.

FIG. 3 is a block diagram of a policy component architecture in accordance with one embodiment of the present invention.

FIG. 4 illustrates resources organized by name according to one embodiment of the present invention.

FIG. 5 is a flowchart of a computer-controlled method of resource management in accordance with one embodiment of the present invention.

### DETAILED DESCRIPTION OF THE INVENTION

Reference will now be made in detail to the various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “comparing,” “representing,” “receiving,” “locating,” “arranging,” “determining,” “identifying,” “traversing,” “indicating,” “listing” or the like, refer to the action and processes (e.g., flowchart 500 of FIG. 5) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention allow the tasks of defining and implementing (evaluating) access control “policies” to be delegated using a policy “referral.” Access control policies can contain “rules,” “subjects” and “conditions” that are evaluated to determine whether access to a “resource” will be granted to a requestor (e.g., a “subject”), and what actions can be performed on or using the resource should access be granted. Referral policies can contain rules, subjects, conditions and referrals. The term “policy definition” is used herein to refer to an access control policy or referral policy that has been defined and which can be implemented in software.

The following is a format that can be used to define a policy, although embodiments of the present invention are not so limited:

[[Rule][Subject][Referral][Condition]].

There can be one or more rules, subjects, referrals and conditions in the policy. Moreover, a policy can be defined without a subject, referral, and/or condition.

A resource (e.g., a service or application) can have more than one policy associated with it. Examples in which there can be multiple policies for a resource would typically exist in an Internet Service Provider (ISP) or Application Service Provider (ASP) environment that hosts multiple organizations, each organization having its own specific policy. These organization-specific policies can be implemented using policy referrals.

As mentioned, policies can be based solely on subject(s). A subject can define an individual user or a collection (group) of users to whom the policy applies. Access to and use of a resource can be granted to a user recognized as having a certain role (e.g., manager) or as being a member of a certain group (e.g., marketing).

Usually, persons or entities identify themselves during the authentication process. Once they have been authenticated, they are provided with one or more identities referred to using the term “principal.” The term “principal” can refer to an identity of the user (or an entity) as represented (or understood) by an application, or a server, or a device.

Hence, a subject can represent a collection of identities, wherein each identity is represented as a principal. For example, Jane Doe is a subject. Jane Doe may have a first e-mail account under the principal name ‘jdoe,’ a second e-mail account under the principal name ‘janedoe,’ and an e-commerce buyer service account under the principal name ‘jane_doe’. Thus, the same subject, Jane Doe, has three principal names (or identities) based on which service she accesses. Principals usually become associated with a subject upon successful authentication to a resource (e.g., an application or a service). Because a subject can represent a nameless container holding relevant information for a user, while principals can represent named identities for that subject, the set of permissions granted to a subject depends on the principals associated with that subject and not on the subject itself.

A rule is a combination of “service type,” “resource,” “action” and “action value.” The following is a format that can be used to define a rule, although embodiments of the present invention are not so limited:

[<Service Type>, <Resource>, [<Action>, <Action Value(s)>]]

There can be one or more action values, and either one resource name or no resource names. A service type is a general term used to identify the type of application, service or device. Service types can be selected from a set of predefined terms. Example service types are Web service, mail service, etc.

A resource is an object defined by the service type and identifiable by a unique name. A resource can be an application or a service, for example. The resource name can be an object name (e.g., MailServer1), a Uniform Resource Identifier (URI) or Uniform Resource Locator (URL), or some other type of unique identifier. A resource can be a Web site such as http://abcweb.abc.com.

An action refers to an operation or an event that can be performed on a resource. An action value refers to the value(s) an action can have. For example, an action can be a get, put, delete, or post operation according to the Hypertext Transfer Protocol (HTTP). For each of these actions, there can be an action value, such as allow/deny or yes/no. Thus, the action value can define whether the action is permitted.

The preceding example illustrates binary actions. Non-binary actions are possible as well. For example, a catalog service could have the following actions: allowed_Discount, purchase_Options, etc. For the catalog service, the allowed_Discount action can have a number as its action value. The purchase_Options action can have certain pre-defined strings as its action values. Hence, action values can be arbitrary in format (e.g., Boolean, numeric, string, single value or multi-valued).

A condition can represent the constraints on a rule or a policy. For example, a constraint can be that an action of updating a catalog can only take place from 8:00 AM-8:00 PM. Another constraint can grant this action only if the request originates from a given set of IP (Internet Protocol) addresses or from the company Intranet.

When a resource is subject to an access control policy, an initial request by a user for access to the resource is evaluated by a policy server, which can also be referred to as a policy decision point, a policy engine or policy evaluator. The policy engine returns a “policy decision.” A policy decision refers to the value(s) returned by the policy engine/server. For example, in the case of Boolean actions, values for the policy decision can be true/false (or allow/deny or yes/no). The policy decision can be used to allow access to a resource, and to define the actions that can be performed on the resource or using the resource after access is gained. In general, a policy decision also includes information identifying the resource(s) to which it applies as well as the subject (e.g., individual user or group of users) to which it applies.

A policy referral involves the concept of forwarding a request for a particular resource from one policy decision point to another for evaluation. For example, in an ISP/ASP environment (and possibly within an enterprise), it may be necessary to delegate the policy definitions, evaluations and decisions for a resource to other organizations or sub-organizations. Taking the example of a Web service, an ISP can refer the policy decision for the resource http://www.acme.com to the ACME organization, and similarly the resource http://www.abc.com to the Abc organization. Additionally, it is possible to delegate the policy definitions, evaluations and decisions for a resource to other products that implement policies (e.g., the delegation can take place across products from different vendors).

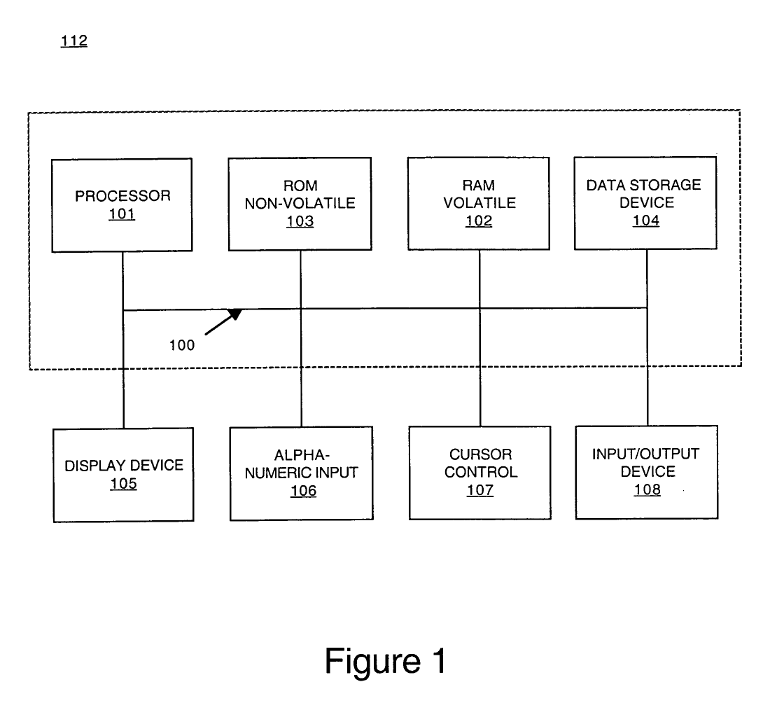

Referring first to FIG. 1, a block diagram of an exemplary computer system 112 is shown. It is appreciated that computer system 112 described herein illustrates an exemplary configuration of an operational platform upon which embodiments of the present invention can be implemented. Nevertheless, other computer systems with differing configurations can also be used in place of computer system 112 within the scope of the present invention.

Computer system 112 includes an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, EPROM, EEPROM, etc.) coupled with bus 100 for storing static information and instructions for processor 101. Computer system 112 can also contain an optional display device 105 coupled to bus 100 for displaying information to the computer user. Moreover, computer system 112 also includes a data storage device 104 (e.g., disk drive) for storing information and instructions.

Also included in computer system 112 is an optional alphanumeric input device 106. Device 106 can communicate information and command selections to central processor 101. Computer system 112 also includes an optional cursor control or directing device 107 coupled to bus 100 for communicating user input information and command selections to central processor 101. Computer system 112 also includes signal communication interface (input/output device) 108, which is also coupled to bus 100, and can be a serial port. Communication interface 108 can also include wireless communication mechanisms.

Access Control Policy Architecture

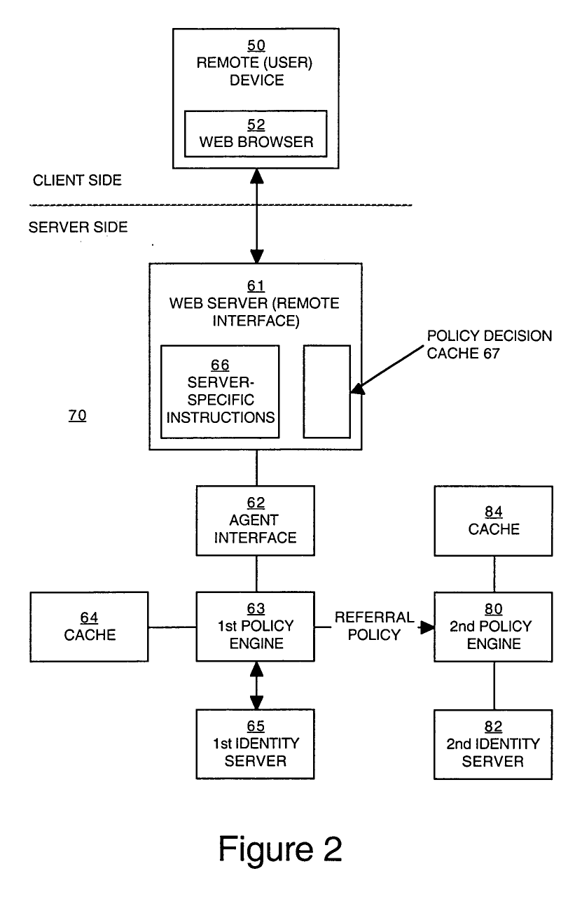

FIG. 2 illustrates an access control policy architecture 70 in accordance with one embodiment of the present invention. The embodiment illustrated by FIG. 2 includes a number of functional blocks illustrated as separate elements. It is appreciated that the functionality provided by any of these elements can be combined and/or integrated with the functionality of one or more of the other elements. It is further appreciated that the architecture 70 can include additional elements not shown or described herein, and that the elements shown by FIG. 2 can implement additional functions not described herein. For example, the identity servers can each be coupled to a directory server that provides a database of user information, or the identity server can incorporate the functionality of a directory server. In addition, it is appreciated that the terms “first” and “second” are not relative terms but are used herein to differentiate between similarly named elements.

In the present embodiment, the architecture 70 includes a Web server 61, such as a Sun™ One Web, Apache, or Microsoft IIS (Internet Information Services) server, although the Web server 61 could be any server running on any platform. The Web server 61 can also be referred to as a remote interface (for the policy engines 63 and 80) or as a policy enforcement point.

The server-specific instructions module 66 is a part of the architecture 70 that is specific to the Web server 61. The server-specific instructions module 66 intercepts an HTTP request for access to a resource on the Web server 61. The server-specific instructions are generally minimal even though different Web servers use different interfaces for implementing HTTP. For example, Sun™ One Web servers use NSAPI (Netscape Server Application Programming Interface) and IIS Web servers use ISAPI (Internet Server Application Programming Interface). However, both NSAPI and ISAPI comply with the same HTTP specifications. Accordingly, the basic mechanism for intercepting an HTTP event and enforcing policy for the resource is the same for both NSAPI and ISAPI.

The first and second policy engines 63 and 80 can also be referred to as policy decision points or policy evaluators. In general, in the present embodiment, the functions of the first policy engine 63 and of the second policy engine 80 include: defining policies for resources; evaluating the policies using the policy definitions; and returning the policy values (policy decisions) to Web server 61 (or an agent that serves Web server 61). The first and second policy engines 63 and 80 can also provide data coherency functions; that is, they can detect changes to the policy definitions, and update the caches 64 and 84 accordingly.

Note that, although in the example of FIG. 2 there are two policy engines, there can be in actuality more than two policy engines. In addition, if policy referrals are not implemented, there can be a single policy engine (e.g., first policy engine 63).

In one embodiment, the policy definitions for first policy engine 63 are stored on first identity server 65, and the policy definitions for second policy engine 80 are stored on second identity server 82. However, first policy engine 63 can utilize a cache memory 64 for storing policy definitions; once a policy definition is loaded in the cache memory 64, the first policy engine 63 does not need to fetch that information from first identity server 65, thus reducing the time it takes to retrieve policy definitions. In a similar manner, second policy engine 80 can store policy definitions in a cache memory 84.

First and second identity servers 65 and 82 can also include directory information or other information used in the definition and evaluation of policies. For example, these servers can have databases that include user (subject) information, such as names, addresses, and the like. These servers can also include attributes that identify which group or groups each subject belongs to (e.g., an attribute for “manager,” another attribute for “marketing,” etc.). Furthermore, these servers can include attributes associating each subject with their principal(s). As mentioned above, the first and second identity servers 65 and 82 can instead retrieve this information from one or more directory servers.

In the present embodiment, when a user makes an initial request for access to a resource, the server-specific instructions module 66 (or an agent providing similar functionality) intercepts the user's initial request and communicates with the first policy engine 63 to determine if the resource is subject to a policy (e.g., an access control policy). If the resource is not subject to a policy, the user's initial request is directed to the resource (that is, access to the resource is granted). Conversely, if the resource is subject to a policy, the user's initial request is referred to first policy engine 63, so that a determination can be made regarding whether or not access to the resource should be granted.

According to the present embodiment of the present invention, either first policy engine 63 or second policy engine 80 will perform the policy evaluation and return a policy decision to Web server 61 for enforcement. Which of these policy engines performs the policy evaluation depends on whether or not a referral policy for the resource of interest is in place in first policy engine 63. In essence, if a referral policy applicable to the resource of interest is in place, the policy evaluation is performed by second policy engine 80; otherwise, the policy evaluation is performed by the first policy engine 63.

Once the policy definition is accessed and the policy evaluation completed (either by first policy engine 63 if there is no referral policy for the resource of interest, or by second policy engine 80 if there is a referral policy for that resource), the Web server 61 (or an agent serving Web server 61) uses the resultant policy decision to enforce the policy decision.

In one embodiment, the policy decision provided to Web server 61 in response to the user's initial request is stored (cached) on Web server 61 in, for example, policy decision cache 67. Because the policy decision is stored at Web server 61, a subsequent request by the same user for the same resource can be evaluated by Web server 61. That is, Web server 61 does not need to refer the request to a policy engine for evaluation, as was the case for the initial resource request.

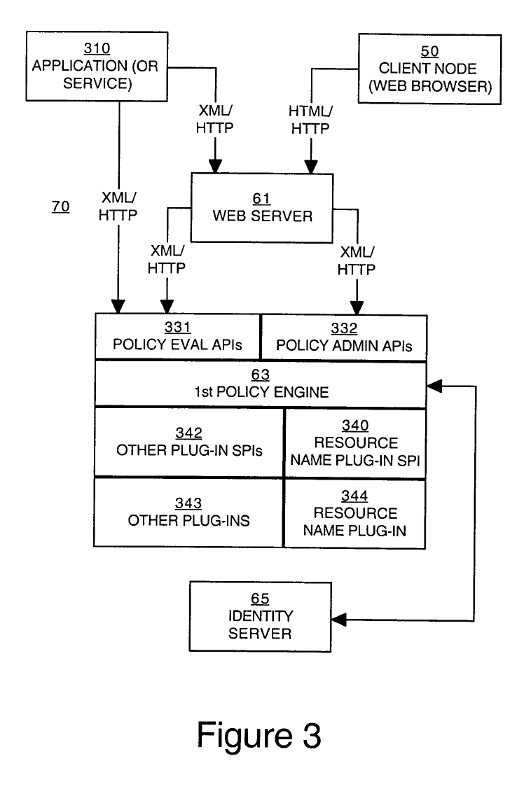

FIG. 3 is a block diagram of one embodiment of a policy component architecture 70 in accordance with the present invention. The embodiment of FIG. 3 illustrates one type of implementation actualizing the embodiment of FIG. 2. The embodiment illustrated by FIG. 3 includes a number of functional blocks illustrated as separate elements. It is appreciated that the functionality provided by any of these elements can be combined and/or integrated with the functionality of one or more of the other elements. It is further appreciated that the architecture 70 can include additional elements not shown or described herein, and that the elements shown by FIG. 3 can implement additional functions not described herein.

Referring to FIG. 3, in the present embodiment, first policy engine 63 incorporates policy evaluation application programming interfaces (APIs) 331 and policy administration APIs 332. The policy evaluation APIs 331 can be used for policy evaluation, and the policy administration APIs 332 can be used by administrators to manage (e.g., set, modify, delete) policy definitions (e.g., rules, etc.). The policy evaluation APIs 331 and the policy administration APIs 332 are implemented with Java or C, although the present invention is not so limited.

In one embodiment, the policy evaluation APIs 331 can interact with applications (or services) 310 that invoke these APIs directly, and the policy administration APIs 332 are targeted for administrators that manage the access control policies via either a browser (on client node 50, for example) or directly via command line interfaces (not shown). In one embodiment, in order to support the use of languages other than Java and C, for example, Web server 61 executes a servlet (not shown) that supports an Extensible Markup Language (XML)/HTTP interface. Accordingly, applications (or services) 310 can construct policy queries using XML and receive policy definitions or evaluate policies by using the servlet on Web server 61. This latter approach can also be used to overcome firewall issues that might prevent messages from applications that use Lightweight Directory Access Protocol (LDAP) from reaching the identity server 65.

According to the present embodiment of the present invention, first policy engine 63 includes a resource name service provider interface (SPI) 340. Resource name plug-in SPI 340 provides an interface for resource name plug-in 344, which is used for resource management based on resource name. The resource name interface is described further below.

The first policy engine 63 can also include a number of other plug-in SPIs 342. Generic plug-ins can be used with the plug-in interfaces 342, or users can instead plug in their own customized modules. Examples of plug-ins 343 include a policy subject plug-in for extending the subject of a policy; a policy referral plug-in for delegating policy decisions as mentioned above; a policy condition plug-in for extending conditions in a policy (e.g., for constraining a policy based on parameters other than a user's credentials); and a conflict resolution plug-in for defining how conflicts are to be handled.

The resource name interface 340 of the present invention is described further by way of example. Consider the following list of resources subject to access control policies:

http://www.abc.com/
http://www.abc.com/AbcStore
http://www.abc.com/MyAbc/
http://www.abc.com/MyAbc/Preferences
http://www.abcweb.central/
http://www.abcweb.central/news
http://www.abcweb.central/benefits/401k

In actuality, such a list may include thousands of entries. Conventionally, in response to a request for access to a resource, each resource in the list would be checked until the resource was located by name. According to the embodiments of the present invention, the list is instead organized in a type of organizational structure such as a tree or hierarchy of resource names.

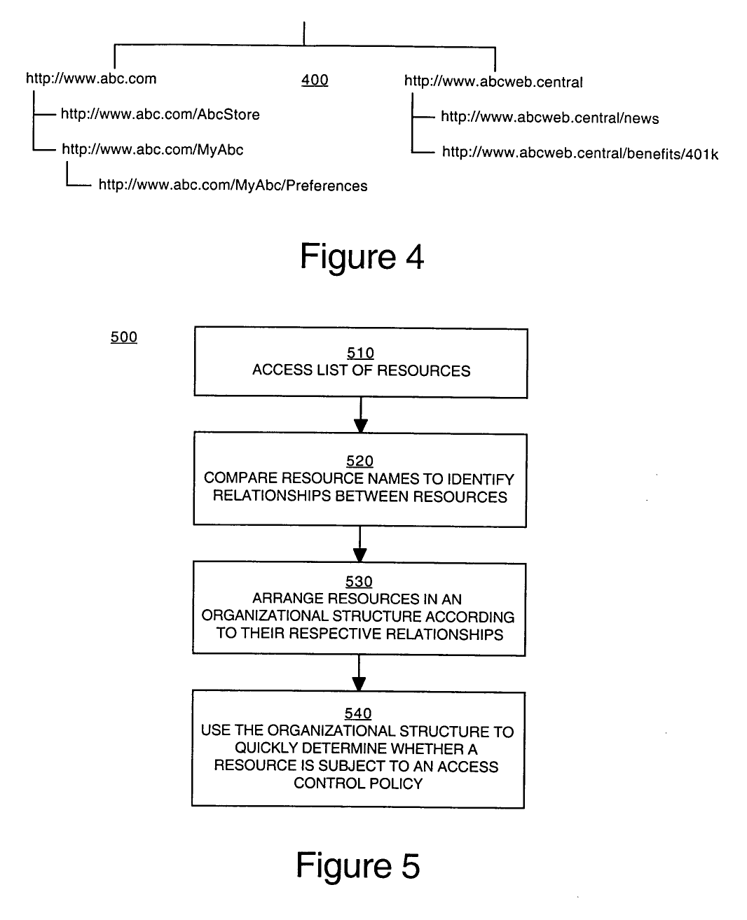

FIG. 4 illustrates an example of an organizational structure 400 according to one embodiment of the present invention. With the resources organized in this or a similar manner, a search by name for a particular resource can be accomplished more quickly and with fewer computational resources. For example, if the resource “http://abcweb.central/news” is requested, the search can be narrowed to the branch that has, as its top level, the resource “http://abcweb.central.” Considering that there can be thousands of resources and policies, the benefits of an organizational structure such as that exemplified by FIG. 4 can be significant.

The resource name plug-in SPI 340 of FIG. 3 is used to represent and/or arrange a list of resources into an organizational structure such as that exemplified by FIG. 4. The resource name interface 340 accomplishes this by comparing resource names to identify the relationship between resources. For example, given two resource names, the resource name interface 340 identifies which resource is the parent or super-resource and which resource is the child or sub-resource. In this manner, relationships between resources in the list are defined, and an organizational structure such as that of FIG. 4 is established based on these relationships.

In one embodiment, the comparison function provided by resource name interface 340 of FIG. 3 utilizes user-defined comparator parameters as the basis for determining the relationship between resources. In one such embodiment, these comparator parameters include user-defined values for: the delimiter used in resource names; a wildcard for wildcard pattern matching of the resource names; and whether or not the resource names are case-sensitive, Each of these parameters is now discussed further.

The delimiter identifies what character or characters are used to separate the various components of a resource name. In the example above, the character “/” is used as the delimiter between name components. Certain delimiters, such as those defined by HTTP, can be ignored.

A wildcard identifies, for example, a string of characters or name components that are to be matched during a comparison of resource names. For example, by specifying “http://www.abc.com/MyAbc/” as the wildcard, all resource names matching that string are identified. This can facilitate subsequent comparisons of resource names by reducing the number of resource names to be compared.

Case-sensitivity is used to identify whether or not the resource names are case-sensitive (e.g., sensitive to the use of lower and upper case characters). If not case sensitive, then “http://www.abc.com/myabc/” is equivalent to “http://www.abc.com/MyAbc/,” for example.

Different comparators can be defined for different types of resources. For example, an LDAP server resource typically has resource names listed as: o=iplanet, o=isp; o=engineering, o=sun, o=isp; o=usa, o=marketing, o=sun. In this case, the character “,” is the delimiter, and the list is traversed from right to left. The delimiter can be specified as “,” by the user, and the resources can then be organized in, for example, a hierarchical organization by the resource name interface 340.

Thus, according to the embodiments of the present invention, the resource name interface is defined generically, but is readily adapted to specific use with different types of resource names. This provides the flexibility for use of the resource name interface when different types of resources are used. In other words, the flexibility afforded by the resource name interface of the present invention allows users to effectively manage their own resources regardless of the type of resources used.

The resource name interface is beneficial as a tool for organizing resources by resource name from a list of resources, for example, when an access control policy architecture is first introduced. The resource name interface is also beneficial when new resources are added. When a new resource is introduced, its place in the organizational structure is readily determined.

Table 1 provides an example of an interface for resource management based on resource name. In this example, the interface is implemented as a Java interface.

TABLE 1
Exemplary Resource Name Interface

```
package com.sun.identity.policy.interfaces;
import java.util.Map;
import java.util.Set;
import com.sun.identity.policy.ResourceMatch;
/* iPlanet-PUBLIC-CLASS */
/**
* The interface <code>ResourceManipulator</code> provides methods to
* determine the hierarchy of resource names. Also, it provides an
* interface to determine the service type with which it is to be used.
* Service develops can provide an implementation of this interface
* that will determine its hierarchy during policy evaluation and also
* its display in a GUI. A class that implements this interface should
* have an empty constructor.
*/
public interface ResourceName {
  /**
    * Gets the service type names for which the resource name object
    * can be used.
    *
    *@return service type names for which the resource comparator
    * can be used.
    */
  public Set getServiceTypeNames( );
  /**
    * Initializes the resource name with configuration information,
    * usually set by the administrators.
    *
    *@param configParams configuration parameters as a map. The keys
    * of the map are the configuration parameters. Each key is
    * corresponding to one <code>String</code> value that specifies
    * the configuration parameter value.
    */
  public void initialize(Map configParams);
  /**
    * Compares two resources.
    *
    * @param origRes: name of the resource that will be compared.
    * @param compRes: name of the resource that will be compared
    with.
    * @param wildcardCompare: flag for wildcard comparison.
    *
    * @return returns <code>ResourceMatch</code> that specifies if the
    * resources are an exact match, or otherwise.
    * ResourceMatch.NO_MATCH means two resources do
    not match.
    * ResourceMatch.EXACT_MATCH means two resources match.
    * ResourceMatch.SUB_RESOURCE_MATCH means compRes
    is the
    * sub-resource of the origRes.
    * ResourceMatch.SUPER_RESOURCE_MATCH means compRes
    is the
    * super-resource of the origRes.
    * ResourceMatch.WILDCARD_MATCH means two resources
    match with
    * respect to the wildcard.
    */
  public ResourceMatch compare (String origRes, String compRes,
  boolean wildcard compare);
  /**
    * Appends sub-resources to super-resources.
    *
    * @param superRes: name of the super-resource to be appended to.
    * @param subRes: name of the sub-resource to be appended.
    *
    * @return returns the combination resource.
    */
  public String append(String superResource, String subResource);
  /**
    * Gets sub-resource from an original resource minus a super-
    * resource. This is the complementary method of append( ).
    * @param res: name of the original resource consisting of the
    * second parameter superRes and the returned value.
    * @param subRes: name of the super-resource which the first
    * parameter begins with.
    *
    * @return returns the sub-resource which the first parameter
    * ends with. If the first parameter does not begin with the first
    * parameter, then the return value is null.
    */
  public string getSubResource(String res, String superRes);
  }
```

Method of Resource Management of Policy Resources

FIG. 5 is a flowchart 500 of a computer-controlled method for resource management of policy resources in accordance with one embodiment of the present invention. Although specific steps are disclosed in flowchart 500, such steps are exemplary. That is, embodiments of the present invention are well suited to performing various other steps or variations of the steps recited in flowchart 500. It is appreciated that the steps in flowchart 500 can be performed in an order different than presented, and that not all of the steps in flowchart 500 may be performed. In one embodiment, the method of flowchart 500 is implemented by a computer system such as computer system 112 of FIG. 1.

In step 510 of FIG. 5, in the present embodiment, a list of resource names is accessed.

In step 520, the resource names are compared to identify the relationships between resources. By comparing resource names, one resource can be identified as a sub-resource of another resource, for example. The comparison utilizes comparator parameters that, in one embodiment, are user-defined. The comparator parameters include definition of the delimiter used to separate name components, definition of a wildcard for wildcard pattern matching, and definition of whether or not the resource names are case-sensitive.

In step 530, once the relationships between resource names have been established, the resources can be represented in an organizational structure such as a hierarchical or tree structure.

In step 540, in response to a request for access to a particular resource, the organizational structure is traversed to locate the resource by name. Once located, the access control policy associated with the resource can be retrieved (if the resource is subject to such a policy), and the request can be evaluated against the policy to determine whether or not access is granted.

In summary, the embodiments of the present invention provide methods and systems that can more efficiently implement access control policies. Resources names are organized so that they can be more readily searched. As a result, searches can be performed more quickly and computational resources are conserved.

Embodiments of the present invention, a resource name interface for managing policy resources, have been described. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of managing resources, said method comprising:
accessing a list of resources, wherein a resource comprises an object defined by a service type and wherein a resource is identifiable by a resource name;
comparing a first resource name for a first resource to a second resource name for a second resource to identify a relationship between said first and second resources; and
representing said first and second resources in an organizational structure reflecting said relationship.

2. The method of claim 1 further comprising:
receiving a request identifying a resource; and
locating said resource in said organizational structure to determine whether said resource is subject to a policy definition governing access to said resource.

3. The method of claim 1 further comprising:
listing said resources in order according to their respective relationships.

4. The method of claim 1 wherein a resource name comprises a plurality of components, wherein one component is separated from another component by a delimiter.

5. The method of claim 4 wherein said comparing comprises:
receiving information identifying what is used as said delimiter.

6. The method of claim 4 wherein said comparing comprises:
receiving information for wildcard pattern matching of resource names.

7. The method of claim 4 wherein said comparing comprises:
receiving information indicating whether a resource name is case-sensitive.

8. The method of claim 1 wherein one of said first and second resources is identified as a sub-resource of the other.

9. A computer system comprising:
a memory unit; and
a processor coupled to said memory unit, said processor for executing a method of managing resources, said method comprising:
receiving a listing of resources, wherein a resource comprises an object defined by a service type and wherein a resource is identifiable by a resource name;
determining a relationship between a first resource and a second resource by comparing their resource names; and
arranging said first and second resources in a hierarchical organization reflecting said relationship.

10. The computer system of claim 9 wherein said method further comprises:
receiving a request to access a resource; and
traversing said organizational structure to locate said resource and determine whether said resource is subject to a policy definition governing access to said resource.

11. The computer system of claim 9 wherein a resource name comprises a plurality of components, wherein one component is separated from another component by a delimiter.

12. The computer system of claim 11 wherein said determining comprises:
identifying a character type used as said delimiter.

13. The computer system of claim 11 wherein said determining comprises:
identifying wildcard pattern used for comparing resource names.

14. The computer system of claim 11 wherein said determining comprises:
indicating whether a resource name is case-sensitive.

15. The computer system of claim 9 wherein one of said first and second resources is identified as a sub-resource of the other.

16. A computer-usable medium having computer-readable program code embodied therein for causing a computer system to perform a method of managing resources, said method comprising:
accessing a list of resources, wherein a resource comprises an object defined by a service type and wherein a resource is identifiable by a resource name;
comparing a first resource name for a first resource to a second resource name for a second resource to identify a relationship between said first and second resources; and
representing said first and second resources in an organizational structure reflecting said relationship.

17. The computer-usable medium of claim 16 wherein said computer-readable program code embodied therein causes said computer system to perform said method further comprising:
receiving a request identifying a resource; and
locating said resource in said organizational structure to determine whether said resource is subject to a policy definition governing access to said resource.

18. The computer-usable medium of claim 16 wherein said computer-readable program code embodied therein causes said computer system to perform said method further comprising:
listing said resources in order according to their respective relationships.

19. The computer-usable medium of claim 16 wherein a resource name comprises a plurality of components, wherein one component is separated from another component by a delimiter.

20. The computer-usable medium of claim 19 wherein said computer-readable program code embodied therein causes said computer system to perform said method further comprising:
receiving information identifying what is used as said delimiter.

21. The computer-usable medium of claim 19 wherein said computer-readable program code embodied therein causes said computer system to perform said method further comprising:
receiving information for wildcard pattern matching of resource names.

22. The computer-usable medium of claim 19 wherein said computer-readable program code embodied therein causes said computer system to perform said method further comprising:
receiving information indicating whether a resource name is case-sensitive.

23. The computer-usable medium of claim 16 wherein one of said first and second resources is identified as a sub-resource of the other.

24. A method of managing resources, said method comprising:
assessing a list of resource names, wherein a resource comprises an object defined by a service type and wherein a resource is identifiable by a resource name having a number of name components, wherein name components are separated by delimiters;
comparing a name component of a first resource name to a name component of a second resource name to identify a relationship between a first resource and a second resource;
organizing said first and second resource names in a hierarchical structure according to said relationship;
receiving a request for access to said resource;
locating said resource in said hierarchical structure; and
determining whether said resource is subject to a policy definition governing access to said resource.

25. The method of claim 24 wherein said comparing comprises:
receiving information identifying a character used as said delimiter.

26. The method of claim 24 wherein said comparing comprises:
receiving information for wildcard pattern matching of resource names.

27. The method of claim 24 wherein said comparing comprises:
receiving information indicating whether said resource name is case-sensitive.
